(19) United States
(12) Patent Application Publication
(10) Pub. No.: US 2011/0096371 A1
(43) Pub. Date: Apr. 28, 2011

(54) DUPLEX SCANNING

(76) Inventors: Paul Mui, Boise, ID (US); Eric Andersen, Meridian, ID (US); Jeffrey C. Madsen, Eagle, ID (US); Scott Putz, Boise, ID (US); Jerry Wagner, Boise, ID (US)

(21) Appl. No.: 12/606,458

(22) Filed: Oct. 27, 2009

(51) Int. Cl. H04N 1/04

(52) U.S. Cl. 358/474

(57) ABSTRACT

In one embodiment, a method for duplex scanning includes: illuminating a first side of an object with light of a first color from a group of colors; sensing the first color light reflected from the first side; illuminating a second side of the object opposite the first side with light of a second color from the group of colors simultaneously with the act of illuminating the first side with the first color light; and sensing the second color light reflected from the second side. In another embodiment, a duplex scanning method includes simultaneously illuminating each side of a document sequentially with each of multiple colors of light but in different color sequences for each side of the document so that the same color light does not illuminate both sides of the document at the same time.

### BACKGROUND

When a document that has images on both sides is scanned, the image on one side of the document may appear in the image scanned on the other side of the document. This irregularity is commonly referred to as “bleed through.” For conventional single pass, “dual-head” duplex scanners, in which images on both sides of the document may be scanned in one pass, the two scan modules must be offset from one another along the document path to avoid transmitting light through the document which can lead to bleed through. Absent this offset, the two scan modules would simultaneously illuminate both sides of the same part of the document with the possibility of some of each module's light transmitting through the document, thus increasing the likelihood that the off side image will appear in each of the scanned images. Offsetting the scan modules, however, adds length to the paper path or height to the scanner.

### DRAWINGS

FIG. 1 is a block diagram illustrating a duplex scanning system according to one embodiment of the disclosure.

FIG. 2 is a side view illustrating a duplex scanner according to one embodiment of the disclosure.

FIG. 3 is a side view illustrating in more detail one embodiment for the scan modules in the duplex scanner shown in FIG. 2.

FIG. 4 is a perspective view illustrating the primary operative components in a CIS scan module.

FIGS. 5-7 illustrate a conventional illumination sequence for duplex scanning.

FIGS. 8-10 illustrate a new illumination sequence for duplex scanning according to one embodiment of the disclosure.

FIG. 11 is a flow chart illustrating a method for duplex scanning according to one embodiment of the disclosure.

The same part numbers designate the same or similar parts throughout the figures.

### DESCRIPTION

Embodiments of the present disclosure were developed in an effort to minimize bleed through in a single pass, dual-head duplex scanner without also increasing the size of the scanner. In one example embodiment, the image on each side of a document is illuminated sequentially with red, green and blue light but in different color sequences for each side so that the same color light does not simultaneously illuminate the image on both sides of the document. We have discovered that this type of “strobing” color illumination technique reduces bleed through in dual-head duplex scanning, thus making it possible to locate the scan modules directly opposite one another across the document path without increasing the risk of bleed through. This Description of example embodiments should not be construed to limit the scope of the disclosure, which is defined in the claims that follow the Description.

As used in this document, a first color and a second color (or a third color, etc.) refers to different colors. Therefore, recitation of a second color “different from the first color” and the like is not needed. Also, as used in this document, “scanner” and “scanning” includes flatbed scanning in which the scan module(s) or other capture device moves past a stationary document or other scan object, sheet feed scanning in which the scan object moves past the capture device, and other image/object capture techniques and devices whether or not the capture device and the scan object move relative to one another.

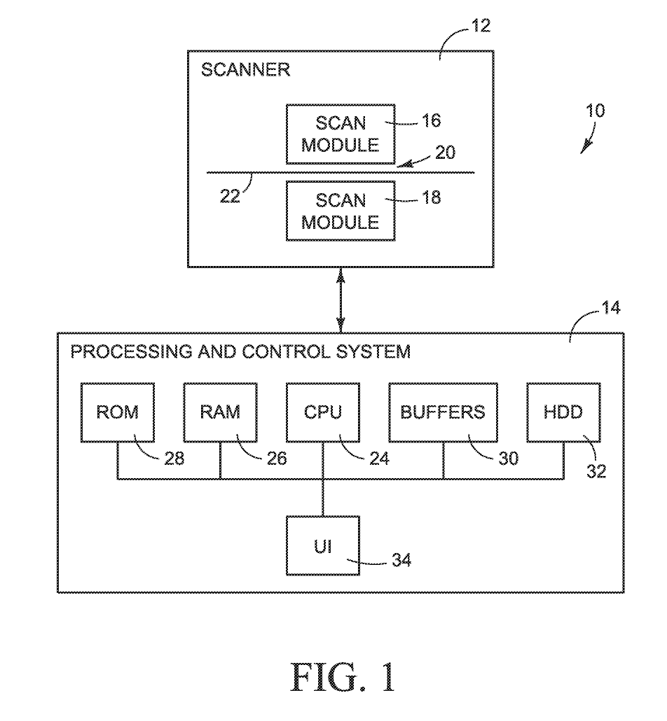

FIG. 1 is a block diagram illustrating one example of a duplex scanning system 10 for implementing embodiments of the present disclosure. Referring to FIG. 1, system 10 includes a scanner 12 and an information processing and control system 14 operatively connected to scanner 12. Scanner 12 includes scan modules 16 and 18 positioned across from one another on each side of a scan station 20 for a document or other object 22 to be scanned. Although embodiments are not limited to scanning a document, but may be implemented with other scan objects, the most common implementation is expected to be document scanning. Therefore, for convenience, reference is made to a document 22 throughout the remainder of this Description. In a flatbed scanner 12, for example, document 22 remains stationary and scan modules 16 and 18 are moved past document 22. In a sheet feed scanner 12, for another example, document 22 is moved past stationary scan modules 16, 18. Information processing and control system 14 represents generally the programming, processor(s) and associated memories, and the electronic circuitry and components needed to control the operative elements of scanner 12 and to process information to and from scanner 12. System 14 may include, for example, a central processing unit 24, random access memory (RAM) 26, read-only memory (e.g., ROM, EPROM or EEPROM) 28, input/output buffers 30, a hard disk drive 32, and a user interface 34.

Scanner 12 and processing and control system 14 may be part of separate devices operatively interconnected to achieve the desired functionality or scanner 12 and processing and control system 14 may be integrated into a single device. For example, a host computer may function as the information processing and control system 14 to a client flatbed or sheet feed scanner 12. In this example, scanner 12 utilizes the host computer for image processing and control functions (although, in this example, scanner 12 typically will also include a local controller to directly control input/output and scan module functions). For another example, scanner 12 and information processing and control system 14 are integrated into a single device, such as a standalone scanner or copy machine. Duplex scanning system 10 might also include elements of both examples, as in the case of a network copier, multi-function peripheral (MFP), or all-in-one device (AIO).

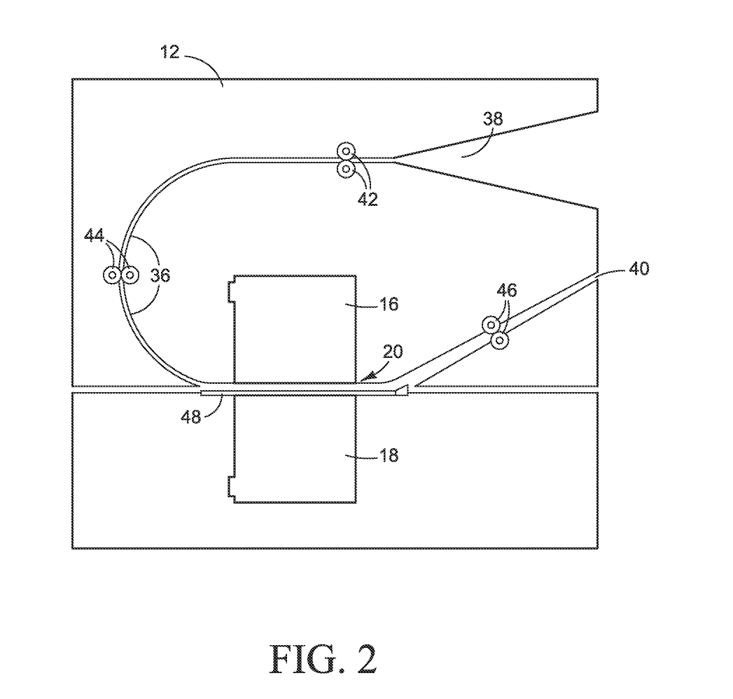

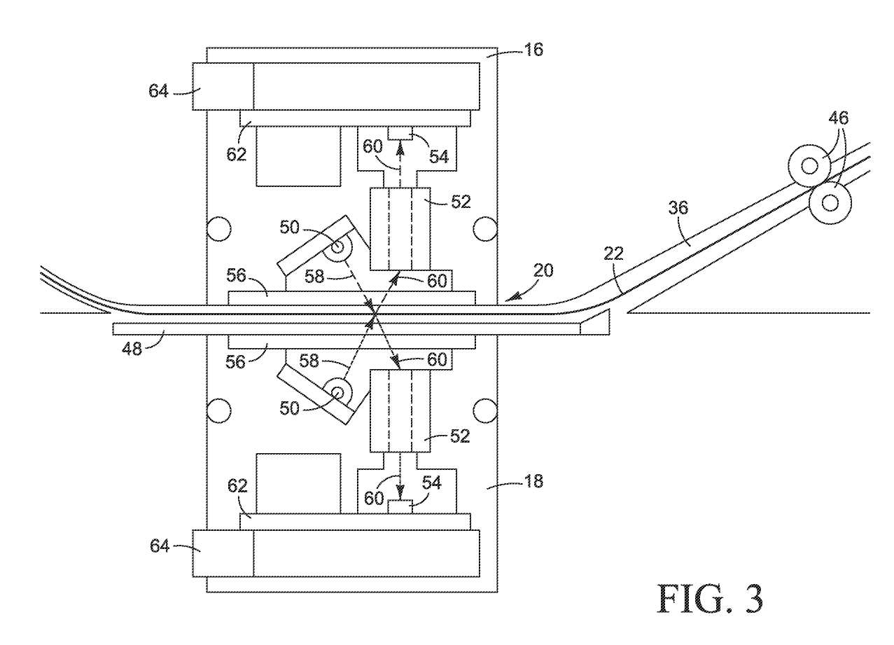

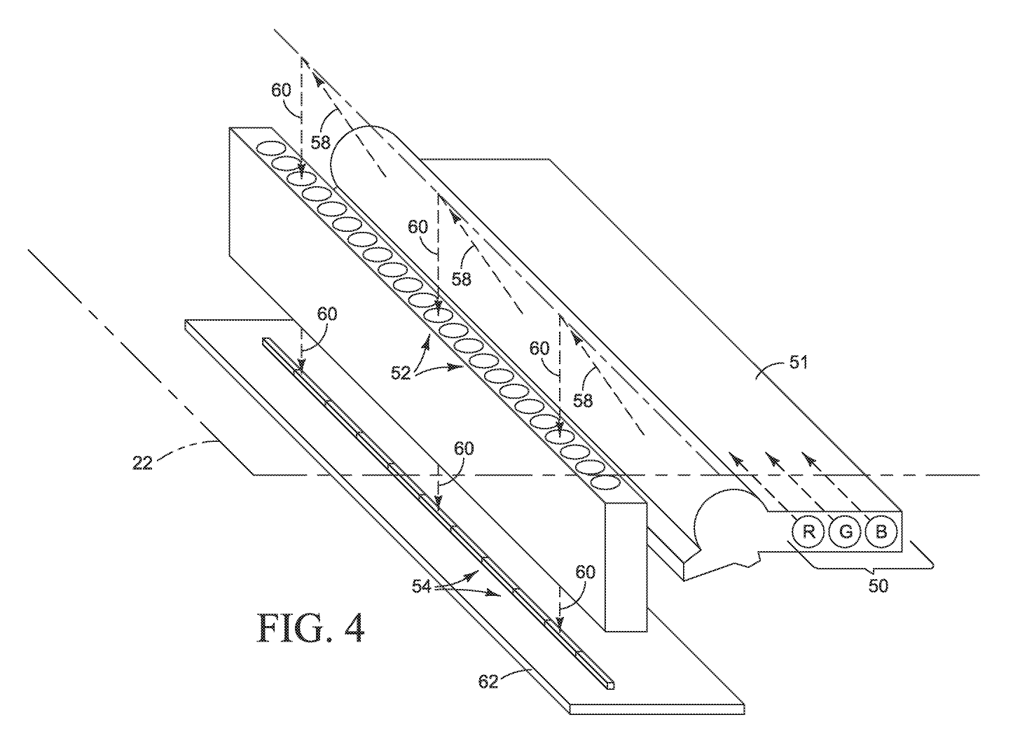

FIG. 2 is a side view illustrating a document path 36 in a sheet feed duplex scanner 12 according to one embodiment of the disclosure. FIG. 3 is a side view illustrating in more detail scan modules 16 and 18 along document path 36. FIG. 4 is a perspective view illustrating the primary operative components in a contact image sensor (CIS) scan module that may be used for modules 16 and 18. Referring first to FIG. 2, documents are moved from an input area 38 along a generally U-shaped document path 36 past scan modules 16, 18 to a discharge area 40 at the urging of transport rollers 42, 44 and 46. Scan modules 16 and 18 are positioned directly opposite one another across document path 36 at the location of a transparent platen 48. Although scan modules 16 and 18 need not be positioned directly across from one another, one of the advantages afforded by the innovative aspects of the present disclosure is the ability to position the scan modules directly opposite one another to help minimize the size of the scanner without also increasing the risk of bleed through.

Referring now also to FIGS. 3 and 4, each scan module 16, 18 includes, for example, a source 50 of multiple colors of light, a lens 52 and a light sensor 54. The configuration of scan modules 16 and 18 shown in FIGS. 3 and 4 is typical of a CIS scan module. Accordingly, in the embodiment shown, color light source 50 represents an array of individual LEDs or other suitable light sources for each of the desired light colors, usually red, green and blue. In one example shown in FIG. 4, color light source 50 includes an array of only one LED for each color and a light guide 51 for projecting light from each LED along the scan line (e.g., laterally across the width of the document). Alternatively, color light source 50 may include an array of multiple LEDs for each color extending along the scan line. Also as shown in FIG. 4, for CIS scan modules 16 and 18, sensor 54 represents a linear array of photo detectors or other suitable light sensors and lens 52 represents, for example, a Selfoc® lens array for focusing light reflected off a document 22 onto the light sensors.

Light from source 50 is projected onto document 22 through a transparent cover 56 (FIG. 3), as indicated by arrows 58 in FIGS. 3 and 4. Light reflected off document 22 (FIG. 3) back through cover 56 passes through lens array 52 onto sensor array 54, as indicated by arrows 60. Sensor array 54 produces electrical signals representative of each scan line, and thus cumulatively for all of document 22. These signals are transmitted to information processing and control system 14 (FIG. 1) for processing into the desired image data. Sensor array 54 may be mounted to a printed circuit board (PCB) 62 as shown in FIG. 3 with connectors 64 for connecting the scan module to external circuits (not shown). Although CIS scan modules 16 and 18 are shown in FIGS. 3 and 4, other implementations for scan modules 16 and 18 are possible. For example, scan modules 16 and 18 might also be implemented as reduction optics scan modules that use CCD light sensors. CCD type light sensors may be sensitive to red, green, and blue light (known as black and white or panchromatic) or they may be an array of sensors in which each sensor is sensitive to red, green, or blue light (filtered). Filtered array CCD sensors provide increased bleed through reduction through improved color discrimination.

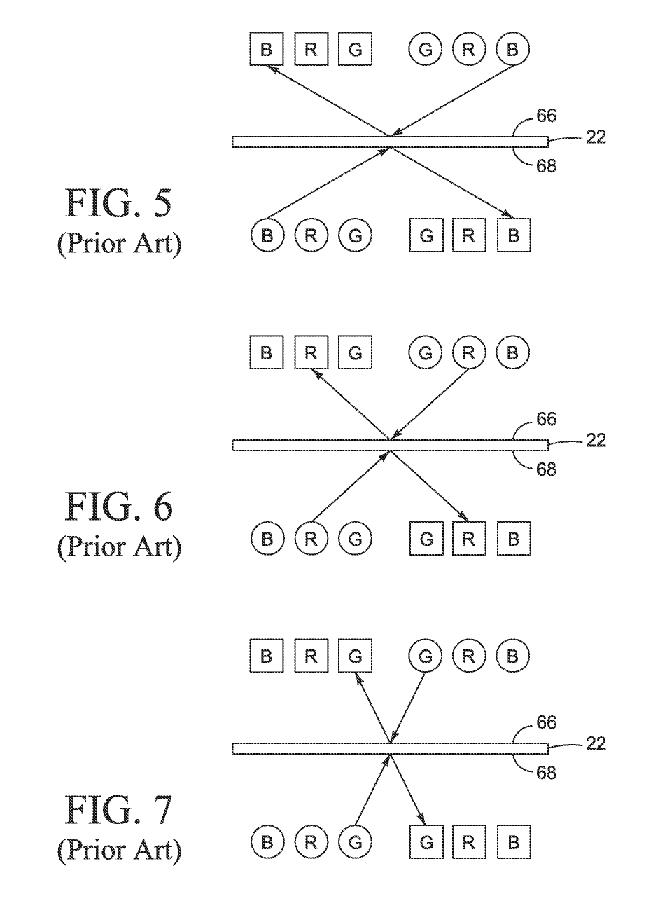

FIGS. 5-7 illustrate a conventional illumination sequence for duplex scanning. FIGS. 5-7 are labeled “Prior Art” because they illustrate an illumination sequence already known in the art of duplex scanning. In the conventional illumination sequence shown in FIGS. 5-7, the image on each side of a document 22 is illuminated sequentially with red, green and blue light in the same color sequence for each side so that the same color light simultaneously illuminates the image on both sides of the document. Thus, both sides 66 and 68 of document 22 are simultaneously illuminated with blue light in FIG. 5, with red light in FIG. 6 and with green light in FIG. 7.

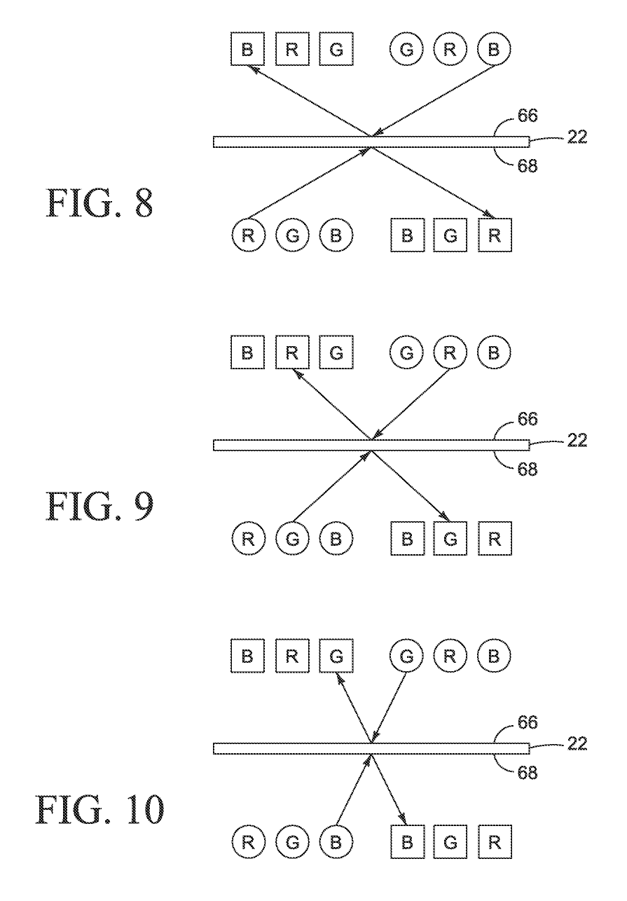

FIGS. 8-10 illustrate one embodiment of a new illumination sequence for duplex scanning. In the new illumination sequence shown in FIGS. 8-10, the image on each side 66, 68 of document 22 is illuminated sequentially with, for example, red, green and blue light but in different color sequences for each side 66, 68 so that the same color light does not illuminate the image on both sides 66, 68 of document 22 at the same time. Thus, for example, document top side 66 is illuminated with blue light while bottom side 68 is simultaneously illuminated with red light as shown in FIG. 8, top side 66 is illuminated with red light while bottom side 68 is simultaneously illuminated with green light as shown in FIG. 9, and top side 66 is illuminated with green light while bottom side 68 is simultaneously illuminated with blue light in FIG. 10. We have discovered that this new strobing color illumination technique reduces bleed through in duplex scanning while still accurately reproducing the images on both sides of document 22.

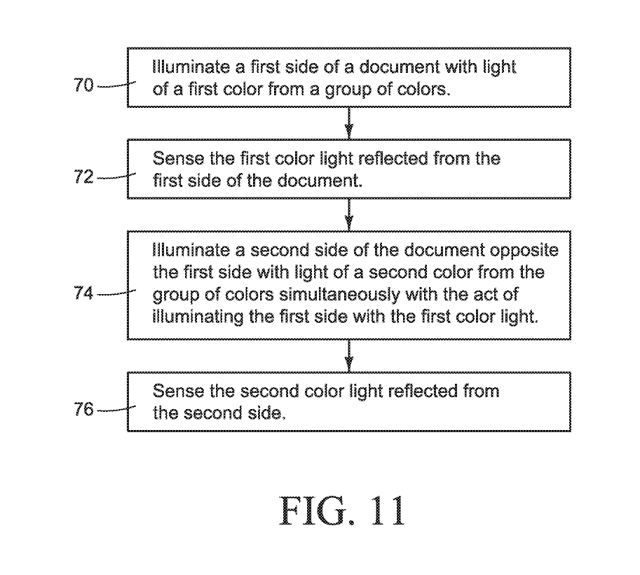

FIG. 11 is a flow chart illustrating a method for duplex scanning that includes an illumination sequence, such as the illumination sequence shown in FIGS. 8-10, according to one embodiment of the disclosure. Referring to FIG. 11, the method includes:

illuminating a first side of a document with light of a first color from a group of colors (block 70);

sensing the first color light reflected from the first side of the document (block 72);

illuminating a second side of the document opposite the first side with light of a second color from the group of colors simultaneously with the act of illuminating the first side with the first color light (block 74); and

sensing the second color light reflected from the second side (block 76).

If the group of colors includes more than two colors (red, green and blue for example), then each of the acts of illuminating and sensing (blocks 70-76) is repeated for each of the other colors in the group of colors. Each act of illuminating the second side is performed simultaneously with a corresponding one of the acts of illuminating the first side and the color of light illuminating the first side is always different from the color of light simultaneously illuminating the second side. For a scanner in which the full scan is made up of many individual scan lines, such as when the document moves past the scan modules, then each of the acts of illuminating and sensing in FIG. 11 (blocks 70-76) may represent illuminating and sensing respective individual locations (a scan line for example) directly opposite one another on each side of the document.

The method shown in FIG. 11 may be implemented in a duplex scanning system 10 shown in FIG. 1 and a scanner 12 such as that shown in FIGS. 2-3, for example through instructions stored on ROM 28 and executed by CPU 24 on processing and control system 14. (“Instructions” in this context are also commonly referred to as logic or programming or computer programming.) Indeed, one of the advantages of the embodiments described above is that the method of FIG. 11 may be implemented using conventional hardware components (e.g., CIS scan modules 16 and 18) operating under the control of instructions stored in the memory components of system 14 (e.g., ROM 28 and HDD 32) and executed by the processing components of system 14 (e.g., CPU 24, RAM 26 and Buffers 30). Portions of the processing and control system 14 (e.g., CPU 24, ROM 28, RAM 26 and Buffers 30) may be implemented in an Application Specific Integrated Circuit (ASIC).

As noted at the beginning of this Description, the exemplary embodiments shown in the figures and described above illustrate but do not limit the invention. Other forms, details, and embodiments may be made and implemented. Therefore, the foregoing description should not be construed to limit the scope of the invention, which is defined in the following claims.

What is claimed is:

1. A method for duplex scanning, comprising:
illuminating a first side of an object with light of a first color from a group of colors;
sensing the first color light reflected from the first side;
illuminating a second side of the object opposite the first side with light of a second color from the group of colors simultaneously with the act of illuminating the first side with the first color light; and
sensing the second color light reflected from the second side.

2. The method of claim 1, wherein:
the act of illuminating the first side comprises illuminating a first location on the first side of the object with the first color light; and
the act of illuminating the second side comprises, simultaneously with the act of illuminating the first side, illuminating a second location on the second side of the object with the second color light, the second location on the second side of the object being directly opposite the first location on the first side of the object.

3. The method of claim 1, wherein the group of colors includes more than two colors and the method further comprises:
repeating the acts of illuminating the first side and sensing light reflected from the first side for each of the other colors in the group of colors; and
repeating the acts of illuminating the second side and sensing light reflected from the second side for each of the other colors in the group of colors;
wherein each act of illuminating the second side is performed simultaneously with a corresponding one of the acts of illuminating the first side and the color of light illuminating the first side is always different from the color of light simultaneously illuminating the second side.

4. The method of claim 3, wherein the group of colors includes red, green and blue.

5. The method of claim 1, wherein the object comprises a document.

6. A duplex scanning method, comprising simultaneously illuminating each side of a document sequentially with each of multiple colors of light but in different color sequences for each side of the document so that the same color light does not illuminate both sides of the document at the same time.

7. The method of claim 6, wherein the multiple colors of light include red, green and blue.

8. A processor readable medium having instructions thereon for causing a scanner to perform a duplex scanning method that comprises:
illuminating a first side of an object with light of a first color from a group of colors;
sensing the first color light reflected from the first side;
illuminating a second side of the object opposite the first side with light of a second color from the group of colors simultaneously with the act of illuminating the first side with the first color light; and
sensing the second color light reflected from the second side.

9. The medium of claim 8, wherein:
the act of illuminating the first side comprises illuminating a first location on the first side of the object with the first color light; and
the act of illuminating the second side comprises, simultaneously with the act of illuminating the first side, illuminating a second location on the second side of the object with the second color light, the second location on the second side of the object being directly opposite the first location on the first side of the object.

10. The medium of claim 8, wherein the group of colors includes more than two colors and the method further comprises:
repeating the acts of illuminating the first side and sensing light reflected from the first side for each of the other colors in the group of colors; and
repeating the acts of illuminating the second side and sensing light reflected from the second side for each of the other colors in the group of colors;
wherein each act of illuminating the second side is performed simultaneously with a corresponding one of the acts of illuminating the first side and the color of light illuminating the first side is always different from the color of light simultaneously illuminating the second side.
